(19) United States
(12) Patent Application Publication
(10) Pub. No.: US 2009/0319909 A1
(43) Pub. Date: Dec. 24, 2009

(54) Data Transfer Systems, Switches, and Method of Providing the Same

(75) Inventors: Chao-Hsuan HSUEH, Taipei (TW); Yu-Ting LIANG, Taoyuan County (TW)

Correspondence Address: YING CHEN;Chen Yoshimura LLP, 255 S. GRAND AVE., # 215, LOS ANGELES, CA, 90012, US

(73) Assignee: ATEN INTERNATIONAL CO., LTD., Shijr City (TW)

(21) Appl. No.: 12/142,587

(22) Filed: Jun. 19, 2008

(51) Int. Cl. G06F 15/16; G06F 3/048

(52) U.S. Cl. 715/740; 709/205

(57) ABSTRACT

A method of transferring data among computers coupled to a switch device is described. The switch device is configured to switch an access between the computers. In this method, data is received from a first computer and transferred to each clipboard of the computers by the switch device by a first user command.

### BACKGROUND

1. Technical Field

The present application relates to data transfer systems, switches, and methods of providing those data transfers.

2. Description of Related Art

Switch systems, such as keyboard-video monitor-mouse (KVM) switch systems, are widely used nowadays for remotely controlling multiple computers or servers from one or more sets of keyboard, video monitor and mouse of client computers. Since the server computers and client computers may spread across floors in a building or located around the globe, the problem of moving data among computers becomes increasingly important.

This demand may be accomplished by using network or alternatively, using removable storage devices, such as floppy disks or USB drives. However, these methods are time consuming and inconvenient especially when data or information to be shared by applications reside on separate computers. For example, when client computer user wants to cite a number calculated by a server computer, or a user wants to copy a link from a client computer's web browser and paste into the web browser on a server computer, there is a need to transfer data between clipboards of computers.

U.S. Pat. No. 6,901,455 one way of sharing clipboard contents. As illustrated in FIG. 1A and its corresponding sequencing diagram shown in FIG. 1B, a user selects some data on a first computer PC1 and issues a copy/cut command at step S110 through a KVM switch device by operating a user console including a keyboard, a mouse and a monitor. The copy/cut command is detected by the KVM switch device to trigger the data transmission from the PC1 to a clipboard of the switch device at step S120. Then user turns to a second computer PC2 and performs a paste request at step S130. The received data is routed from the switch device to the clipboard of the PC2 at step S140. Accordingly, the transferred data is pasted into an application on the second computer at step S150 using a standard paste command. If any other computer (e.g. a PCn) wants to share the data, the user needs to send another paste command to the KVM switch device at step S160 to indicate another data transmission from the KVM switch to the clipboard of the PCn at step S170. The data will be accepted on the PCn at step SI 80. Thus, if the user wants to insert the data into applications on multiple computers, the steps of transferring data from the KVM switch device to the clipboards of the multiple computers (e.g. S140 and S170) are updated repeatedly but separately.

U.S. Pat. No. 7,139,842 described another way of sharing certain content. As illustrated in FIG. 2, a cut/paste request generated by a user is detected by the switch device at step 210 (such as a first dedicated predetermined event). Data associated with user-ID of the first computer is copied and stored in a clipboard of the KVM switch device in response to the cut/paste request. Then user enables the keyboard-video-mouse to communicate and access a second selected computer. Similarly, the switch device will be waiting for a paste request at step 220 (such as a second dedicated predetermined event)to determine whether the received data will be sent out to the clipboard of the second computer.

In both methods, switch devices waited for paste requests to determine the destination of the received data. It may be desirable in some applications to allow access to certain common data by a number of computers at the same time.

### SUMMARY

In one embodiment according to the present invention, a method of transferring data is described. Data is received from a first computer of at least two computers by a switch device. The switch device is configured to switch an access between the at least two computers. The received data is transferred to each clipboard of the at least two computers.

In another embodiment according to the present invention, a method of transferring data between a first computer and a second computer is described. A first user command is received from the first computer. The first user command is configured to identify a data content. The data content is provided to clipboard area of the second computer. The clipboard area of the second computer is configured to allow the second computer to provide the data content upon receiving a second user command.

Still another embodiment according to the present invention, a user-interface switch system is described. A first interface is configured to be coupled to a first computer and to receive a first user command from the first computer. The first user command is configured to identify a data content. A second interface is configured to be coupled to a second computer and to provide the data content to clipboard area of memories of the second computer. The clipboard area of the second computer is configured to allow the second computer to provide the data content upon receiving a second user command.

Still another embodiment according to the present invention, a method of transferring data between a first computer and a second computer comprises the steps of: connecting a KVM switch between the first computer and the second computer; receiving a first user command from the first computer, the first user command being configured to identify a data content in the first computer; and transmitting the data content to the second computer, the data content being stored in a clipboard area of the second computer, the clipboard area being configured to allow the second computer to access the data content upon receiving a second user command. The data content may comprise at least one of a text, a formatted text, an image, a formatted image, an electronic file, and a file folder. The data content may comprise a desktop of the first computer.

Still another embodiment according to the present invention, an user-interface switch system is described. The system includes a set of connectors, a first interface and a second interface. The set of connectors is configured to be coupled to a set of console including input and display devices. The first interface is configured to be coupled to a first computer and to identify a data content on the first computer in response to a first user command via the set of connectors. The second interface is configured to be coupled to a second computer, and to provide the data content to the second computer. The data content is stored in a clipboard area of a memory of the second computer, the clipboard area is configured to allow the second computer to provide the data content upon receiving a second user command via the set of connectors.

Still another embodiment according to the present invention, a method of transferring data between a first computer, a second computer and a third computer comprises the steps of connecting a KVM switch between the first, second and third computers; receiving a first user command from the first computer, the first user command being configured to identify a data content in the first computer; transmitting the data content to the KVM switch from the first computer; and broadcasting the data content to the second and third computers from the KVM switch, the data content being stored in a clipboard area of each of the second and third computers, the clipboard area being configured to allow one of the second and third computers to provide the data content upon receiving a second user command.

### BRIEF DESCRIPTION OF THE DRAWINGS

The foregoing summary, as well as the following detailed description of the embodiments, will be better understood when read in conjunction with the appended drawings. The embodiments illustrated in the figures of the accompanying drawings herein are by way of example and not by way of limitation. In the drawings:

FIG. 1A is a block diagram showing a method of transferring data between computers of the prior art.

FIG. 1B is a sequencing diagram showing steps of transferring data corresponding to the block diagram shown in FIG. 1A.

FIG. 2 is a flow diagram showing another method of transferring data between computers of the prior art.

FIG. 3 illustrates a workstation according to one embodiment consistent with the present invention.

FIG. 4 illustrates an operation of transferring data according to one embodiment consistent with the present invention.

FIG. 5 illustrates a block diagram of a two-port KVM switch according to one embodiment consistent with the present invention.

FIG. 6 illustrates a method of transferring data over network according to one embodiment consistent with the present invention.

FIG. 7 illustrates another method of transferring data over network according to one embodiment consistent with the present invention.

FIG. 8 illustrates another method of transferring data over network according to one embodiment consistent with the present invention.

FIG. 9 is an exemplary flow chart of a method of transferring data between computers according to one embodiment consistent with the present invention.

### DETAILED DESCRIPTION

The following illustrates embodiments consistent with the invention. However, skilled artisans may implement or operate techniques, systems and operating structures consistent with the present invention in a wide variety of forms and modes not limited to the variations illustrated below. The specific structural and functional details disclosed herein are merely representative without limiting the scope of the invention.

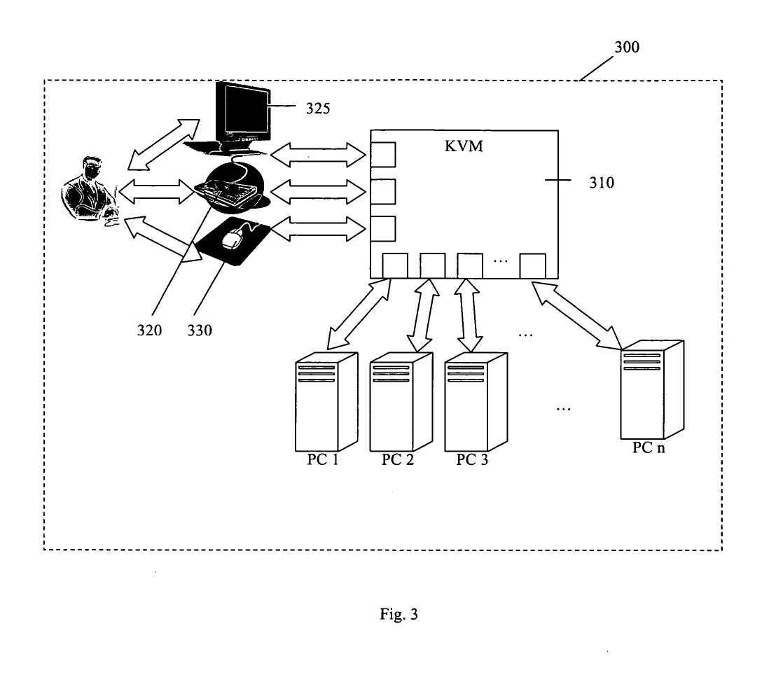

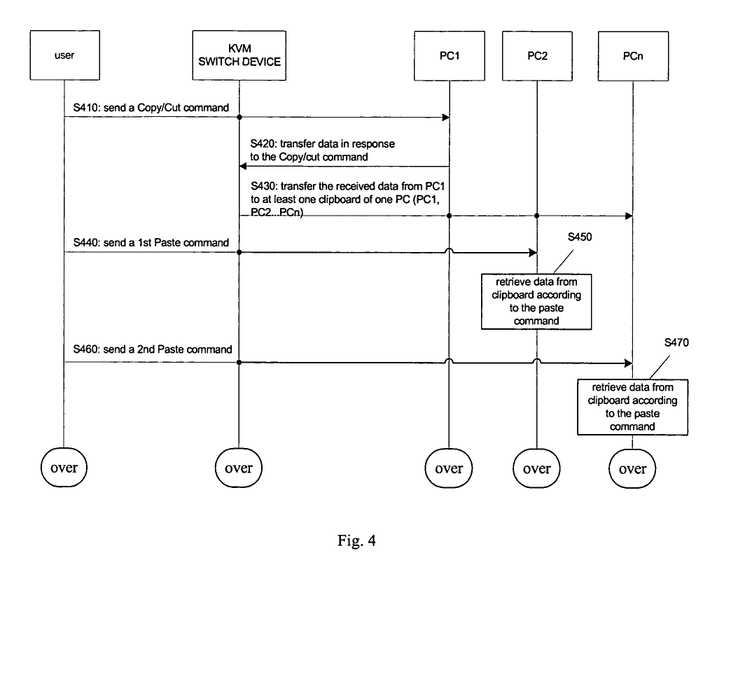

FIGS. 3 and 4 illustrate a workstation and a method of operating data transfer between the computers in accordance with one embodiment of the present invention. As shown in FIG. 3, a workstation 300 may comprise a KVM switch device 310 to switch an access between a plurality of computers (e.g. PC1 and PCn). The plurality of computers may be coupled with the KVM switch device 310 by a direction communication linkage or over a network. In various embodiments, the communication linkage between computers may be Internet, Intranet, Ethernet, Local area network (LAN), Wide area network (WAN), bluetooth, wireless network or USB. A user may operate each computer through KVM switch device 310 by a console including a keyboard 320, a video monitor 325 and a cursor or a pointer device, such as a mouse 330. The switch device 310 may comprise at least one user interface through which user commands are received, thereby performing data transfer between the computers. The switch device 310 may also comprise a controller, for example, a microprocessor, a complex programmable logic device (CPLD), a field programmable gate array (FPGA) or an application specific integrated circuit (ASIC) which may interface the plurality of computers.

An example embodiment of the sequencing operation of data transfer is shown in FIG. 4. In the operation, the user may select one of the plurality of computers to execute applications or programs by a set of devices associated with a console including the keyboard 320, the video monitor 325 and the mouse 330 via the KVM switch device 310. The console may identify and select some data in an application or select an electronic file on PC1 and initiate a first user command through a first interface of the KVM switch device 310, for example, a copy/cut command at step S410. In response to the first user command, PC1 transfers the selected data to the KVM switch device 310 at step S420. For example, the first user command may trigger the KVM switch device 310 to copy the selected data or electronic file from PC1 to a buffer or memory of the KVM switch device 310 at step S420. The command for triggering the KVM switch device 310 can be expressed in a number of ways, including mouse, key strokes or other inputs well known in the art. In one embodiment, the selected data may be desktop data which corresponds to the function of making one computer use the same user interface as on another one. Once the selected data is received by the KVM switch device 310, conventionally, the switch device 310 may wait for an event (e.g. a paste request issued by the user on the PC2) to trigger the transportation of data to a particular computer. In contrast, in example embodiments of the invention, when the selected data is received and placed in the buffer or the memory of the KVM switch device 310, the received data may be effectively broadcast and provided to at least one clipboard of one computer (e.g., PC2) through a second interface of the KVM switch device 310 at step S430, so as to allow an immediate paste operation on that computer (e.g., PC2) using a standard paste command. In this manner, if multiple computers, for example, PC2 and PCn want to share the selected data, the received data may be provided to each clipboard of PC2 and PCn upon receiving the first user command. As a result, the user may retrieve clipboard contents on PC2 and PCn at steps S450 and S470 by executing paste commands at steps S440 and S460 without repeatedly transporting the data from the switch device to each clipboard of each computer to satisfy each paste request, which enhances the efficiency of data transfer between a plurality of computers.

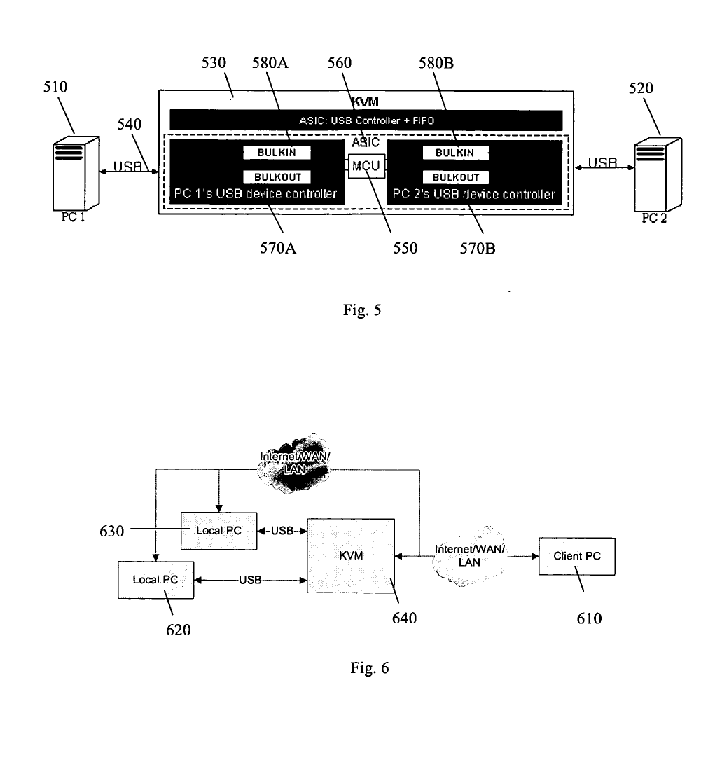

As discussed above, the plurality of computers may be coupled with the switch device by establishing a direct communication linkage via a universal serial bus, parallel bus, CAT-5 cable or in any other manner. FIG. 5 shows block diagram of an exemplary 2-port KVM switch device. The KVM switch device may be a multi-port KVM switch device. In this embodiment with reference to FIG. 5, computers 510 and 520 interface the KVM switch device 530 via a universal serial bus (USB) 540 using USB bulk transfer pipe. The KVM switch device 530 may comprise a controller. The controller may be a micro controller unit (MCU) 550 or an application specific integrated circuit (ASIC) 560 in some embodiments. In other embodiments the controller may be a complex programmable logic device (CPLD) or a field programmable gate array (FPGA). The switch device 530 may further comprise two sets of bulk endpoints (e.g. BULKOUT endpoint 570A and BULKIN endpoint 580A) to control the data transmission between the computers 510 and 520. In one embodiment, the computer 510 may send data to the KVM switch device 530 using the BULKOUT endpoint 570A. When application data is received by the KVM switch device 530 via the BULKOUT endpoint 570A, the ASIC 560 may generate an interrupt to indicate the MCU 550 or place the received data directly into a memory or buffer requiring no MCU intervention. When a command (e.g. a paste command) is sent out from the KVM switch device 530 to the computer 520, the MCU 550 or the ASIC 560 may route the received data from the KVM switch device 530 to the computer 520 using the BULKIN endpoint 580B. Thus the received data is forwarded from the computer 510 to the computer 520 via the KVM switch device 530. The data transmission from the computer 520 to the computer 510 is performed in a similar way. For example, the computer 520 may send data to the KVM switch device 530 using the BULKOUT endpoint 570B. When application data is received by the switch device 530 via the BULKOUT endpoint 570B, the ASIC 560 may generate an interrupt to indicate the MCU 550 or place the received data directly into a memory or buffer requiring no MCU intervention. When a command (e.g. a paste command) is sent out from the KVM switch device 530 to the computer 510, the MCU 550 or the ASIC 560 may route the received data from the switch device 530 to the computer 510 using the BULKIN endpoint 580A. Thus the received data may be forwarded from the computer 520 to the computer 510 via the KVM switch device 530. Once there is data copied/cut from the computer 510, MCU or ASIC provides the data to all the other PCs (e.g., the computer 520), and vice versa. In other words, KVM may pass the data from the source PC (e.g., the computer 510) to other KVM-associated PCs (e.g., the computer 520).

In other example embodiments, the plurality of computers may be coupled with the switch device over a network, such as local access networks (LANs), wireless LANs, Internet, Intranet, Ethernet, bluetooth, wireless network and any other computer communication network. The network may include wireless and/or satellite components. One example embodiment of transferring data over the network is illustrated in FIG. 6. In this embodiment, a user (e.g., a client PC 610) may communicate with server computers (e.g., computers 620 and 630) over the network using TCP/IP protocols (Transmission Control Protocol/Internet Protocol), which provides a high performance and security management on the target computers 620 and 630. In this manner, the data may be transmitted from a source computer (e.g., the computer 620) to a destination computer (e.g., the client PC 610) via TCP/IP. The computers 620 and 630 may be coupled with the KVM switch device 640 via universal serial bus (USB) or over network. The data transmission between the computer 620 and the client PC 610 may be executed in a similar way to the data communication between the computer 630 and the client PC 610.

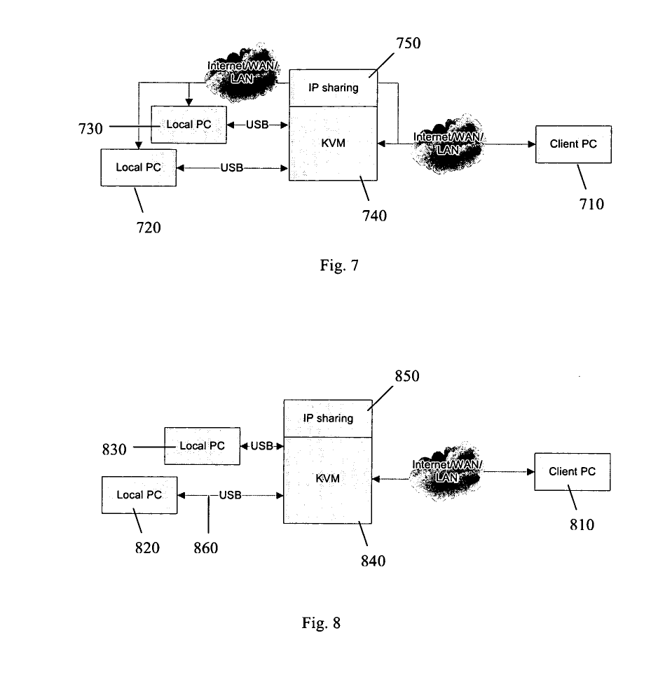

In another embodiment as illustrated in FIG. 7, the KVM switch device 740 uses an IP (Internet Protocol) sharing block 750 to transmit digital signals for managing the keyboard, video and mouse outputs of the computers 720 and 730 using standard TCP/IP protocols. In this way, a user may control the computers 720 and 730 from anywhere over Internet. Computers coupled with the KVM switch 740 may share data or applications by one or more sets of keyboard, video monitor and mouse around the world. The data transmission between the computer 720 and the client PC 710 may be performed in a similar way to the data transmission between the computer 730 and the client PC 710. In this configuration, data may be transmitted from a source computer (e.g., the computer 720) to a destination computer (e.g. the client PC 710) through the IP sharing block in the KVM switch device 740.

Still another embodiment of transferring data between computers is shown in FIG. 8. Referring to FIG. 8, (e.g. a client PC 810) may remotely access and control computers 820 and 830 through a switch device 840 using an IP sharing block 850. Data to be copied from the computers 820 and 830 may be received by the KVM switch device 840 via a universal serial bus (USB) 860 using USB bulk transfer pipe. The received data may then be sent out to the client PC 810 over network using TCP/IP protocols. The data transmission between the computer 820 and the client PC 810 may be performed in a similar way to the data communication between the computer 830 and the client PC 810.

In various embodiments, the KVM switch devices may offer USB capability which allows users to share any USB device that is located on remote computers (e.g. the computers 620, 720 and 820) over a network and use it as if it was plugged into your own computer.

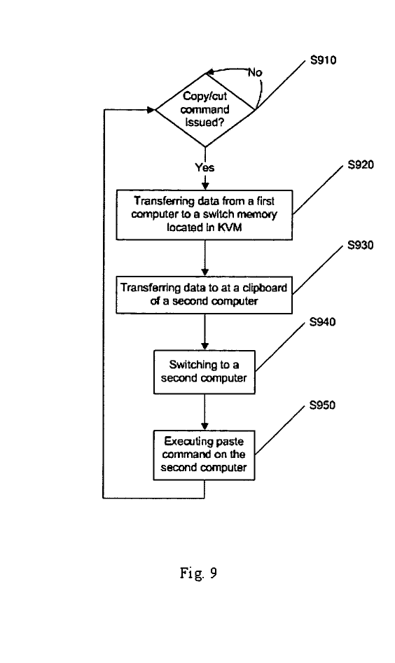

Remotely controlling data transmission between multiple computers by one or more sets of keyboard, video monitor and mouse of client computers is generally illustrated by a flow diagram in FIG. 9. A user may select one of a plurality of computers to operate some applications or programs through a KVM switch over network or direct connections. The plurality of computers may be coupled with the KVM switch via a universal serial bus (USB) using USB bulk transfer pipe, or over network using TCP/IP protocols. When user selects some data, such as a text message, an electronic file, a user interface or a desktop, and sends a copy/cut command at step S910, the KVM switch device may route the selected data from the particular computer (e.g. the computer 720 in FIG. 7) to a buffer or memory of the KVM switch device at step S920 in response to the copy/cut command. The received selected data is then broadcast and transferred to a clipboard of at least one computer (e.g., the computer 730) within the network at step S930, so as to allow an immediate operation of the transferred selected data on the particular computer (e.g. the computer 730) at step S940. When the user switches an access to the computer 730, the transferred data may be retrieved from the clipboard of the computer 730 by a paste command at step S950. In another example embodiment, the received data may be provided to each clipboard of multiple computers within the network thus making the data available on the clipboard of the multiple computers and ready for future use. When paste commands are initiated subsequently on each of the multiple computers, the data may be retrieved from the each clipboard of the multiple computers. Thus repeated data transmission from the KVM switch to each clipboard of the plurality of computers may be avoided.

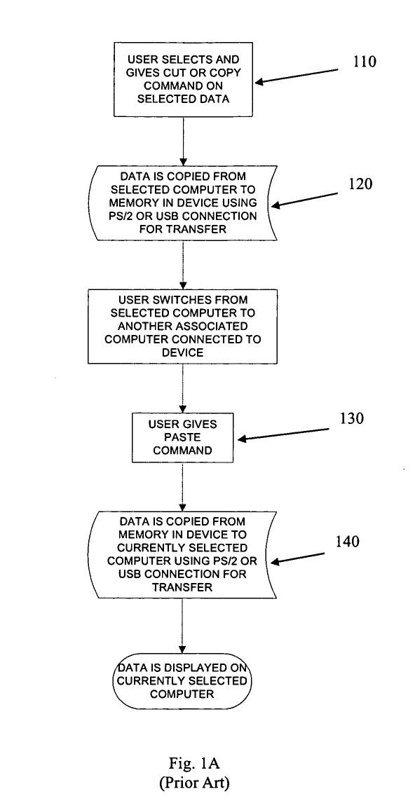

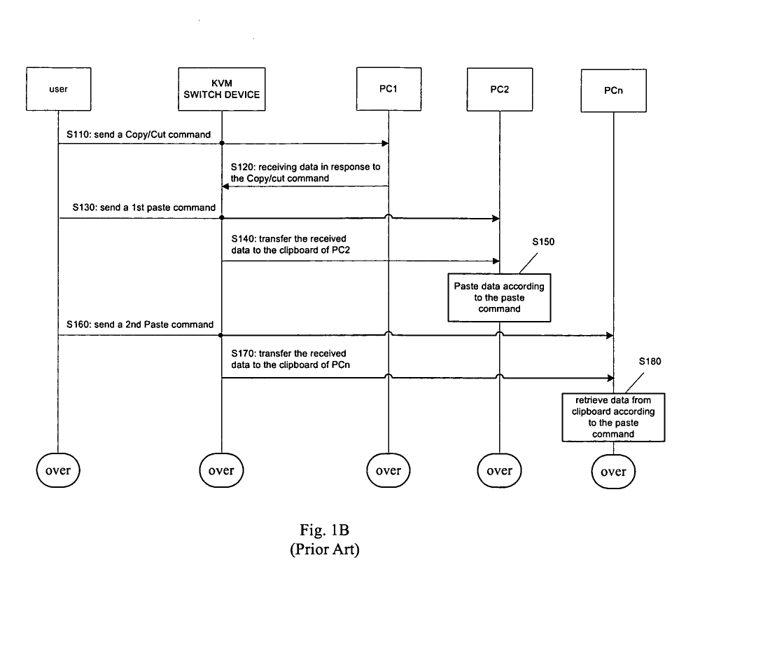

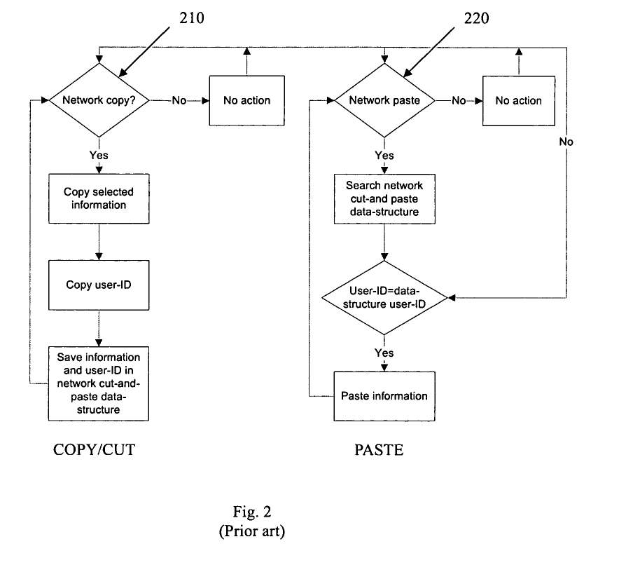

In some applications in the prior art, depending on the designs, some devices may have time-consuming or inefficient problems because the copied data may not be available on the clipboard of the destination computer until a second command is executed. For example, referring to FIG. 1, the received data is transferred to the destination computer PC2 at step S140 after the execution of the paste command at step S130. In contrast, in various embodiments of the present invention, the copied/cut data may be broadcast to the clipboard of the destination computer and be available for future use right after the copy/cut command is executed and before the second command (step 130 in FIG. 1A or step 220 in FIG. 2) is initiated. In this way, the data is transferred and retrieved on the destination computer efficiently.

It will be appreciated by those skilled in the art that changes could be made to the examples described above without departing from the broad inventive concept thereof. It is understood, therefore, that this invention is not limited to the particular examples disclosed, but it is intended to cover modifications within the spirit and scope of the present invention as defined by the appended claims.

What is claimed is:

1. A method of transferring data between a first computer and a second computer, comprising:
connecting a KVM switch between the first computer and the second computer;
receiving a first user command from the first computer, the first user command being configured to identify a data content in the first computer; and
transmitting the data content to the second computer, the data content being stored in a clipboard area of the second computer, the clipboard area being configured to allow the second computer to access the data content upon receiving a second user command.

2. The method of claim 1, wherein the KVM switch couples to at least one set of user input and display devices with the first and second computers.

3. The method of claim 1, further comprising providing a program being executed in the first and second computers and the program being configured to receive the first and second user commands.

4. The method of claim 1, wherein the first user command comprises at least one of a copy and a cut command and the second user command comprises a paste command.

5. The method of claim 1, wherein transmitting the data content to the second computer is achieved through transmitting the data content using at least one of an internet protocol (IP), a transmission control protocol/internet protocol (TCP/IP), a bluetooth protocol, and a universal serial bus (USB) protocol.

6. The method of claim 1, wherein the data content comprises at least one of a text, a formatted text, an image, a formatted image, an electronic file, and a file folder.

7. The method of claim 1, wherein the data content comprises a desktop of the first computer.

8. The method of claim 1, wherein the clipboard area is a memory area of the second computer, and the data content is stored in the clipboard area after receiving the first user command and before receiving the second user command.

9. The method of claim 1, wherein transmitting the data content to the second computer is in response to the first user command.

10. An user-interface switch system comprising:
a set of connectors configured to be coupled to a set of console devices including input and display devices;
a first interface configured to be coupled to a first computer and to identify a data content on the first computer in response to a first user command via the set of connectors; and
a second interface configured to be coupled to a second computer, and to provide the data content to the second computer, the data content being stored in a clipboard area of a memory of the second computer, the clipboard area being configured to allow the second computer to provide the data content upon receiving a second user command via the set of connectors.

11. The system of claim 10, wherein the first and second computers further comprise a program executed therein and configured to receive the first and second user commands respectively.

12. The system of claim 10, wherein the first user command comprises at least one of a copy and a cut command to identify the data content on the first computer and the second user command comprises a paste command.

13. The system of claim 10, wherein at least one of the first and second interfaces comprises an interface compatible with at least one of an internet protocol (IP), a transmission control protocol/internet protocol (TCP/IP), a bluetooth protocol, and a universal serial bus (USB) protocol.

14. The system of claim 10, wherein the data content comprises at least one of a text, a formatted text, an image, a formatted image, an electronic file, and a file folder.

15. The system of claim 10, wherein the clipboard area is a memory area of the second computer, and the data content is stored in the clipboard area after receiving the first user command and before receiving the second user command.

16. The system of claim 10, transmitting the data content to the second computer via the second interface in response to the first user command.

17. The system of claim 10, further comprising an Application Specific Integrated Circuit (ASIC) and a microcontroller unit (MCU) coupled with the first and second interfaces.

18. The system of claim 10, further comprising a third interface configured to be coupled to the second computer and to transmit the second user command to the second computer via the set of connectors.

19. A method of transferring data between a first computer, a second computer and a third computer, comprising:
connecting a KVM switch between the first, second and third computers;
receiving a first user command from the first computer, the first user command being configured to identify a data content in the first computer;
transmitting the data content to the KVM switch from the first computer; and
broadcasting the data content to the second and third computers from the KVM switch, the data content being stored in a clipboard area of each of the second and third computers, the clipboard area being configured to allow one of the second and third computers to provide the data content upon receiving a second user command.

20. The method of claim 19, wherein the clipboard area is a memory area of each of the second and third computers, and the data content is stored in the clipboard area of one of the second and third computers after receiving the first user command and before receiving the second user command.

21. The method of claim 19, wherein transmitting the data content to the second and the third computers is in response to the first user command.

22. A method of transferring data between a first computer and a second computer, the method comprising:
receiving a first user command from the first computer, the first user command being configured to identify a data content; and
providing the data content to the second computer, the data content being stored in a clipboard area of the second computer, the clipboard area being configured to allow the second computer to provide the data content upon receiving a second user command.
